(19) United States
(12) Patent Application Publication
(10) Pub. No.: US 2021/0179475 A1
(43) Pub. Date: Jun. 17, 2021

(54) Modular Bottle Etching or Scoring Apparatus, Systems and Methods of Using the Same

(71) Applicant: Creator's Stained Glass, Inc., Spring Grove, IL (US)

(72) Inventors: Ray Nicholas, Ingleside, IL (US); Jordan Anderson, Gurnee, IL (US); Ryan Nicholas, Ingleside, IL (US)

(21) Appl. No.: 16/715,979

(22) Filed: Dec. 16, 2019

(51) Int. Cl. C03B 33/10; C03B 33/06

(52) U.S. Cl. CPC C03B 33/107; C03B 33/06

(57) ABSTRACT

Modular bottle etching apparatuses, systems and methods of using the same comprise modular bottle stage elements for holding a bottle and turning a bottle, and a modular etching element having a blade thereon for scoring a glass bottle, or any glass tubular or cylindrical item. The modular bottle stage elements and the modular etching elements are movable, thereby accommodating different sized bottles thereon for precise scoring with the blade.

### TECHNICAL FIELD

The present invention relates to modular bottle etching or scoring apparatuses, systems and methods of using the same. Specifically, the modular bottle etching or scoring apparatuses comprise modular bottle stage elements for holding a bottle and turning a bottle, and a modular etching or scoring element having a blade thereon for scoring a glass bottle, or any glass tubular or cylindrical item. The modular bottle stage elements and the modular etching or scoring elements are movable, thereby accommodating different sized bottles thereon for precise etching or scoring with the blade.

### BACKGROUND

Bottle etching apparatuses are known, but are difficult to use to etch a scoreline effectively. There are many different techniques to cut a bottle, most involving a blade that scores the bottle circumferentially so that the same may be cracked, providing a clean separation at the score line. However, other techniques include using a hot wire or hot string in an attempt to break the bottle along a desired line. These techniques have proven to be difficult, and in many cases can be dangerous.

Specifically, the technique of wrapping a bottle with a hot wire or hot string is particularly difficult to produce a clean score line. In most cases, wrapping a hot wire or string around a bottle and attempting to crack along the string or wire leads to shattering of the bottle, which is, of course, very dangerous.

Another technique involves utilizing a high-speed spinning blade to score or cut a glass bottle. While this may be relatively quick and effective, the machines tend to be expensive and also dangerous in that the spinning blades could cause bodily damage. And if not properly used, the spinning blade can cause the bottle to break irregularly, also leading to a dangerous situation with glass shards.

The more common method to cut a bottle involves the afore-mentioned blade scoring of the bottle circumferentially around the bottle. Once scored, the bottle is then impinged by extreme heat, extreme cold, and/or a tapping device to finish the separation of the bottle along the score line. Other techniques have also developed, including applying sources of hot and/or cold to the score line to effectuate the class separation.

Indeed, bottle cutting jigs have been developed to make bottle cutting easier, less dangerous, and less expensive for users, especially hobbyists. FIG. 1 illustrates a popular, highly effective, and well-known bottle cutter. While the prior art bottle cutter shown in FIG. 1 can effectively and efficiently score a bottle for separation of the same, there are some notable drawbacks. First, it may be difficult to provide sufficient pressure of the blade against the bottle during scoring of the same. The score line should be relatively deep; the deeper the score line, the easier to separate the bottle along the score line while minimizing shattering or breakage of the bottle around the score line. However, the blade is held against the bottle via a spring, in the prior art illustrated in FIG. 1. If the spring is not sufficient, the score line will likely be shallow or non-existent, making the separation of the bottle very difficult if not impossible to do cleanly. A need, therefore, exists, for an improved bottle cutting apparatus. Specifically, a need exists for an improved bottle cutting apparatus that provides sufficient pressure on the blade to ensure that the score line imparted is sufficiently deep to effectuate clean separation of the glass.

Ideally, the score line should wrap around the exterior surface of the bottle circumferentially and meets at the end of the score line exactly where it started. Thus, when separated, the score line provides a clean break around the bottle. In many bottle cutters, however, it may be particularly difficult to control the score line to ensure that it meets exactly where it started. A need, therefore, exists for an improved bottle cutting apparatus that imparts a score line that effectively wraps circumferentially around an entirety of the bottle. Moreover, a need exists for an improved bottle cutting apparatus that allows the score line to effectively meet back where it started so that there is no gap when attempting to separate the glass along the score line.

Moreover, typical bottle cutter jigs are designed for a small number of bottle sizes—typically, standard wine-bottle sizes. This is so because oftentimes the components of the bottle cutting jig are stationary and immovable, and as such only certain sized bottles may be placed within the jig for cutting the same. However, it may be desirable to be able to score any size or shape bottle. Typical heretofore known bottle cutters that do allow for movement of elements to accommodate different sized bottles are typically difficult to use and do not provide effective scoring of the bottles. A need, therefore, exists for an improved bottle cutting apparatus that may accommodate different sized and shaped bottles. More specifically, a need exists for an improved bottle cutting apparatus having modular and easily movable elements that can be easily configured to accommodate the differences in sizes and shapes of bottles scored therein.

### SUMMARY OF THE INVENTION

The present invention relates to modular bottle etching apparatuses, systems and methods of using the same. Specifically, the modular bottle etching apparatuses comprise modular bottle stage elements for holding a bottle and turning a bottle, and a modular etching element having a blade thereon for scoring a glass bottle, or any glass tubular or cylindrical item. The modular bottle stage elements and the modular etching elements are movable, thereby accommodating different sized bottles thereon for precise scoring with the blade.

To this end, in an embodiment of the present invention, A bottle scoring apparatus is provided. The bottle scoring apparatus comprises: a base comprising a plurality of retention cells, wherein each retention cell comprises at least one wall and an open top; a first wheel assembly comprising a post, a rotating wheel attached to the post, and a peg on an end of the post, wherein the peg is shaped and sized to fit within the plurality of retention cells, wherein the peg on the post of the first wheel assembly is frictionally held within a first cell of the plurality of retention cells; and a blade assembly comprising a first post and a glass scoring blade attached to the first post, wherein the first post of the blade assembly comprises a peg on an end of the first post of the blade assembly, wherein the peg is shaped and sized to fit within the plurality of retention cells, wherein the peg on the first post of the blade assembly is frictionally held within a second cell of the plurality of retention cells.

In an embodiment, the peg on the post of the first wheel assembly is configured to be removed from the first cell of the plurality of retention cells.

In an embodiment, the peg on the post of the first wheel assembly is configured to be frictionally held within a third cell of the plurality of retention cells.

In an embodiment, the peg on the first post of the blade assembly is configured to be removed from the second cell of the plurality of retention cells.

In an embodiment, wherein the peg on the first post of the blade assembly is configured to be frictionally held within a fourth cell of the plurality of retention cells.

In an embodiment, the blade assembly comprises a second post, wherein the second post comprises a peg on an end thereof, wherein the glass scoring blade is held between the first post and the second post, wherein the peg on the second post of the blade assembly is frictionally held within a third cell of the plurality of retention cells.

In an embodiment, both the peg on the first post of the blade assembly and the peg on the second post of the blade assembly are configured to be removed from the first cell and the third cell of the plurality of retention cells, respectively.

In an embodiment, the bottle scoring apparatus of claim 7 wherein the peg on the first post of the blade assembly and the peg on the second post of the blade assembly are configured to be frictionally held within a fourth cell and a fifth cell of the plurality of cells, respectively.

In an embodiment, the bottle scoring apparatus further comprises: a second wheel assembly comprising a post, a rotating wheel attached to the post, and a peg on an end of the post, wherein the peg on the post of the second wheel assembly is shaped and sized to fit within the plurality of retention cells, wherein the peg on the post of the second wheel assembly is frictionally held within a third cell of the plurality of retention cells.

In an embodiment, the first wheel assembly and the second wheel assembly are positioned on the base to hold a bottle therebetween, wherein the rotating wheels of the first and second wheel assemblies, respectively, rotate the bottle held thereon.

In an embodiment, the bottle scoring apparatus further comprises: a third wheel assembly comprising a post, a rotating wheel attached to the post, and a peg on an end of the post, wherein the peg is shaped and sized to fit within the plurality of retention cells, wherein the peg on the post of the third assembly is frictionally held within a fourth cell of the plurality of retention cells.

In an embodiment, the first wheel assembly, the second wheel assembly, and the third wheel assembly are positioned on the base to hold a bottle thereon, wherein the rotating wheels of the first, second and third wheel assemblies, respectively, allow the bottle to be rotated thereon.

In an embodiment, the bottle scoring apparatus further comprises: a stopper assembly comprising a post, a stopper attached to the post, and a peg on an end of the post, wherein the peg on the post of the stopper assembly is sized and shaped to fit within the plurality of retention cells, wherein the peg on the post of the stopper assembly is frictionally held within a third cell of the plurality of retention cells.

In an embodiment, the peg on the post of the stopper assembly is configured to be removed from the third cell of the plurality of cells.

In an embodiment, the peg on the post of the stopper assembly is configured to be frictionally held to a fourth cell of the plurality of retention cells.

In an embodiment, the stopper is adjustable towards and away from the post of the stopper assembly.

In an embodiment, the stopper comprises a stopper element, a threaded shaft extending from the stopper element through the post of the stopper assembly, and a dial attached on an end of the threaded shaft, wherein the stopper is adjustable towards and away from the post of the stopper assembly via turning the dial and the threaded shaft.

In an embodiment, the first wheel assembly and the blade assembly are configured to move to different locations on the base to accommodate different sized bottles thereon.

In an alternate embodiment of the present invention, a method of using the bottle scoring apparatus is provided. The method comprises the steps of: removing the first wheel assembly from the first cell of the plurality of retention cells; and placing the peg of the post of the first wheel assembly in a third cell of the plurality of cells, wherein the peg of the post of the first wheel assembly is frictionally held within the third cell of the plurality of cells.

In an embodiment, the method of using the bottle scoring apparatus of claim 19 further comprising the steps of: removing the blade assembly from the second cell of the plurality of retention cells; and placing the peg on the first post of the blade assembly in a fourth cell of the plurality of retention cells.

It is, therefore, an advantage and objective of the present invention to provide an improved bottle cutting apparatus.

Specifically, it is an advantage and objective of the present invention to provide an improved bottle cutting apparatus that provide sufficient pressure on the blade to ensure that the score line imparted is sufficiently deep and clean to effectuate clean separation of the glass.

In addition, it is an advantage and objective of the present invention to provide an improved bottle cutting apparatus that imparts a score line that effectively wraps around an entirety of the bottle.

Moreover, it is an advantage and objective of the present invention to provide an improved bottle cutting apparatus that allows the score line to effectively meet back where it started so that there is no gap when attempting to separate the glass along the score line.

Further, it is an advantage and objective of the present invention to provide an improved bottle cutting apparatus that may accommodate different sized and shaped bottles.

More specifically, it is an advantage and objective of the present invention to provide an improved bottle cutting apparatus having modular and easily movable elements that can be easily configured to accommodate the differences in sizes and shapes of bottles scored therein.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art bottle etching apparatus.

FIG. 2 illustrates a modular bottle etching apparatus in an embodiment of the present invention.

FIG. 3 illustrates a front view of a modular bottle etching apparatus and a bottle placed thereon for scoring thereof in an embodiment of the present invention.

FIG. 4 illustrates a rear view of a modular bottle etching apparatus and a bottle placed thereon for scoring thereof in an embodiment of the present invention.

FIG. 5 illustrates a roller wheel assembly for a modular bottle etching apparatus in an embodiment of the present invention.

FIG. 6 illustrates an adjustable stopper assembly for a modular bottle etching apparatus in an embodiment of the present invention.

FIG. 7 illustrates a bottle scoring blade assembly for a modular bottle etching apparatus in an embodiment of the present invention.

FIG. 8 illustrates a top view of a modular bottle etching apparatus in an embodiment of the present invention.

FIG. 9 illustrates a top view of a modular bottle etching apparatus showing wheel assemblies, a stopper assembly, and a bottle scoring blade assembly in alternate positions in an embodiment of the present invention.

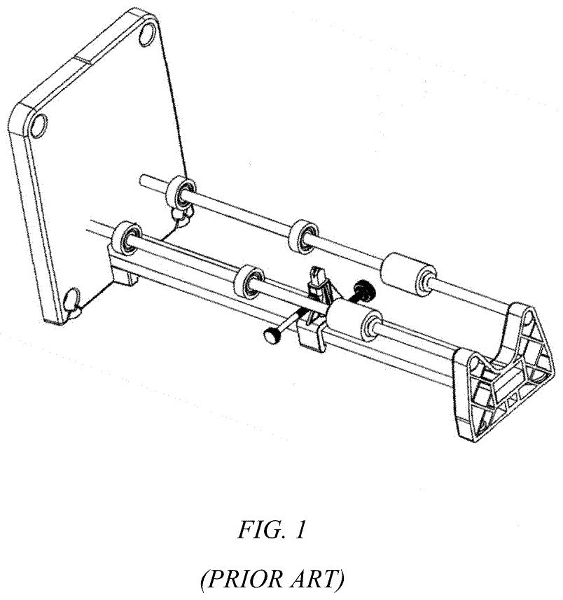

### DETAILED DESCRIPTION OF THE PRESENTLY PREFERRED EMBODIMENTS

The present invention relates to modular bottle etching apparatuses, systems and methods of using the same. Specifically, the modular bottle etching apparatuses comprise modular bottle stage elements for holding a bottle and turning a bottle, and a modular etching element having a blade thereon for scoring a glass bottle, or any glass tubular or cylindrical item. The modular bottle stage elements and the modular etching elements are movable, thereby accommodating different sized bottles thereon for precise scoring with the blade.

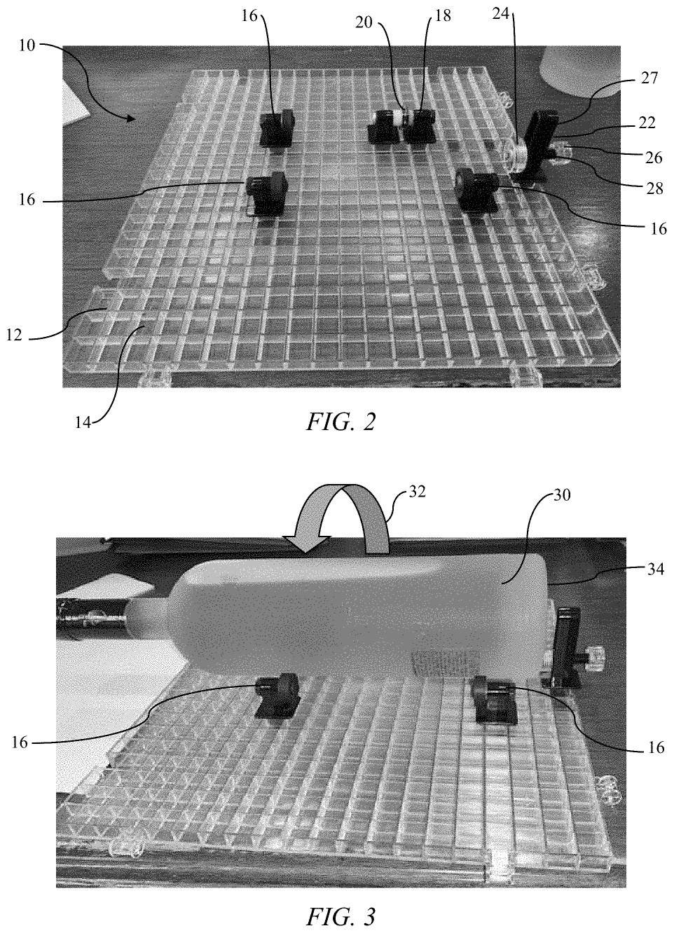

Now referring to the drawings, wherein like numerals refer to like parts, a modular bottle scoring apparatus 10 is illustrated in an embodiment of the present invention. The modular bottle scoring apparatus 10 comprises a base 12 having a plurality of retention cells 14 therein. Each of the cells 14 comprises a recessed volume having at least one wall, preferably, a plurality of walls, and an opening on a top thereof. As illustrated in FIG. 2, the base 12 comprises a grid of cells 14, each of which may be used for holding elements described in more detail below.

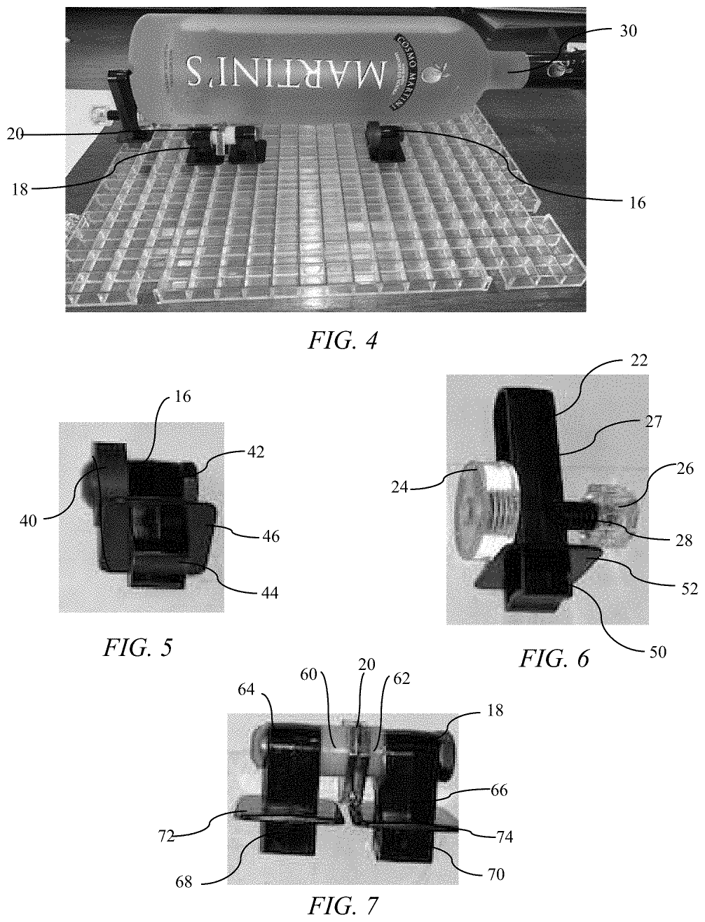

The modular bottle scoring apparatus 10 comprises a plurality of wheel assemblies 16 disposed in relative positions so as to rotatably hold a bottle 30 thereon, as illustrated in FIG. 3. Moreover, the modular bottle scoring apparatus 10 comprises a blade assembly 18 that provides contact of a blade 20 to a surface of the bottle 30 when placed on the plurality of wheel assemblies 16, as illustrated in FIG. 4.

As shown in FIGS. 3 and 4, the wheel assemblies 16 form a holder or cradle for the bottle 30 placed thereon. A user may placed the bottle 30 on the plurality of wheel assemblies 16, and the wheel assemblies 16 may be aligned so that the user can rotate the bottle 30 by turning the same in the direction 32 (or in a counter-direction, not shown). The blade 20 on the blade assembly 18 may be positioned to contact the surface of the bottle 30 so that when rotated, the blade 20 scores the surface of the bottle 30 when the bottle is rotated by the user. Therefore, the blade 20 may be positioned at the appropriate height and angle to interact with the surface of the bottle 30 to etch the scoreline therein. As the user rotates the bottle 30, preferably pushing down on the surface of the bottle 30, the scoreline is etched circumferentially around the bottle 30.

Once scored, the bottle 30 may be removed from the modular bottle scoring apparatus 10 and the score may be used to separate the bottle at the score, as is apparent to one of ordinary skill in the art. It is generally known how to separate a bottle when a score is circumferentially etched therein. For example, the scored bottle may be heated at the site of the score circumferentially therearound, and then chilled rapidly, such as by placing in an ice bath, whereupon the score may separate the bottle into two pieces.

To ensure that the bottle 30 maintains its position so that the score etched therein is accurately scored circumferentially therearound (i.e., to ensure that the scoreline etched therein meets where it starts when rotated), a stopper assembly 22 may be positioned in a location such that a bottom 34 of the bottle 30 may rest thereagainst, as illustrated in FIGS. 3 and 4. The stopper assembly 22 may comprise a stopper 24 that is attached to a rotating knob 26 through an axle 28, as illustrated in FIG. 6, that may be attached through a post 27.

The axle 28 may be threaded, such that rotating the rotating knob 26 moves the stopper 24 away from and toward the post 27, respectively, depending on the direction of rotation of the rotating knob 26. Thus, the position of the bottle 30 and, more importantly, the scoreline that may be etched therein, can be precisely placed on the bottle 30. For example, a user may wish to etch a scoreline in a particular location on the bottle 30. By placing the bottle 30 on the rotating wheel assemblies 16, and then moving the stopper 24 via the rotating knob 26, the precise placement of the scoreline on the surface of the bottle 30 may be achieved.

The wheel assemblies 16 are illustrated in close-up detail in FIG. 5. The wheel assemblies 16 comprise a rotating wheel 40 attached to a post 42. On a bottom of the post 42 may be a peg 44 and a flange 46 therearound. The peg 44 may fit snugly within one of the cells 14, and the flange 46 may allow a user to press the wheel assemblies 16 fully therein so that the same rests in a preferred fully inserted in one of the cells 14. The peg 44 may be removed from one of the cells 14 and re-inserted into a different cell 14. Thus, each of the wheel assemblies 16 may be moved from one cell 14 to another cell 14 within the base 12 so that each may be moved to any location. This may be useful to change the size of the “cradle” formed by the wheel assemblies 16 to accommodate different sized bottles.

Moreover, the stopper assembly 22 may have the stopper 24, the rotating knob 26, the axle 28, and the post 27, as described above. Moreover, as illustrated in FIG. 6, the stopper assembly 22 may have a peg 50 on a bottom of the post 27, and a flange 52 that may allow a user to press the stopper assembly 22 into one of the cells 14 so that the same rests in a preferred fully inserted position in one of the cells 14. As with the wheel assemblies 16, the stopper assembly 22 may be removed from its cell 14 and re-inserted into a different cell 14 within the base 12. Thus, the stopper assembly 22 may be moved into any position to accommodate different sized bottles, and/or to change the location of the scoreline on the surface of the bottle 30.

As illustrated in FIG. 7, the cutter assembly 18 comprises the blade 20 that may be rigidly held in place between two shafts 60, 62 that are each positioned between two posts 64, 66. At the bottom of each post 64, 66 may be pegs 68, 70, respectively, and flanges 72, 74, respectively. As with the wheel assemblies 16 and the stopper assembly 22, the pegs 68, 70, and the flanges 72, 74 may sized and positioned to be pushed into respective cells 14 so that the blade assembly 18 may be rigidly held in place. Using two pegs 68, 70 may provide stability for the blade 20, thereby holding it in place when a bottle is etched thereby. The blade assembly 18 may be pressed into the cells 14 and the flanges may assure that the pegs 68, 70 are fully inserted therein and the blade assembly 18 is level. If the scoreline position on the bottle 30 is desired to be in a different location on the surface of the bottle 30, the blade assembly 18 may be removed from its cells 14 and re-inserted into different cells 14 within the base 12. Thus, the blade assembly 18 may be moved into any position to accommodate different sized bottles and/or to change the location of the scoreline on the surface of the bottle 30.

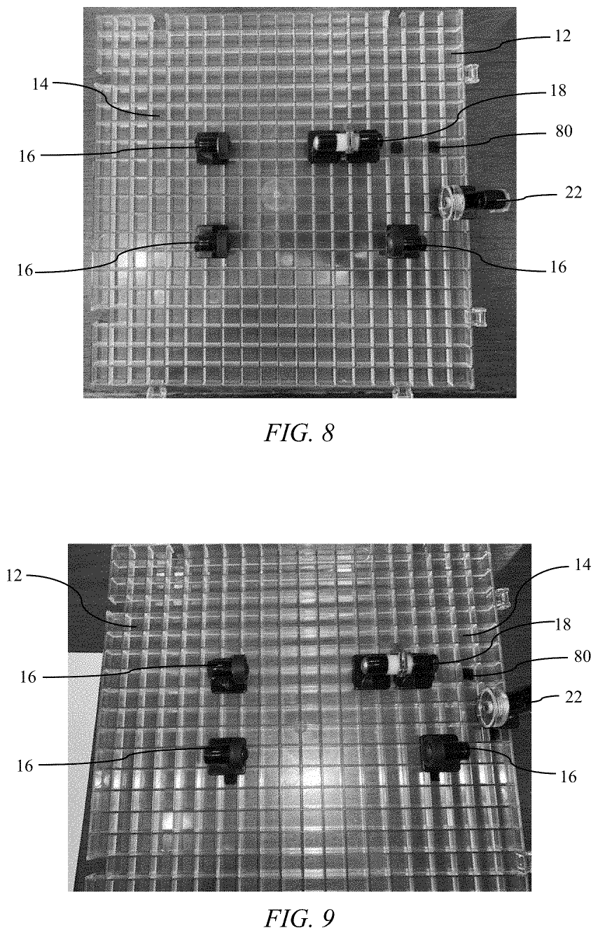

For example, as illustrated in FIGS. 8 and 9, the blade assembly 18 may be moved from a first position, shown in FIG. 8 to a second position, shown in FIG. 9. Therefore, the scoreline etched into the surface of the bottle 30 may be changed based on where the blade assembly is placed. Likewise, each of the wheel assemblies 16 and the stopper assembly 22 may be moved into any location on the base 12 as desired, to accommodate various sized bottles and to place the scoreline in any desired location on bottles etched thereon. Respective cells 14 may be marked with a marker 80 indicating various positions that may be useful for specific sized bottles, aiding in the placement of the various assemblies for etching a bottle.

To assure that the bottle is rigidly held in position on the wheel assemblies 16, the scoreline is precise and accurate, each of the wheel assemblies 16, the blade assembly 18, and the stopper assembly 22 may be rigidly frictionally held within their respective cells, and preferably do not easily move when placed therein. However, each should be able to be removed by a user thereof simply by pulling the same out of each respective cell 14 without undue force.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1: A bottle scoring apparatus comprising:
a base comprising a plurality of retention cells, each retention cell forming a square opening, four sides and a bottom, wherein each of the retention cells is uniform in size, shape and orientation, the plurality of retention cells forming a grid over the entirety of the base wherein each retention cell is uniformly spaced apart from adjacent retention cells, wherein each retention cell comprises at least one wall and an open top;
a first wheel assembly comprising a post, a rotating wheel attached to the post, and a peg on an end of the post, wherein the peg of the first wheel assembly is unitary with the post of the first wheel assembly, wherein the peg of the first wheel assembly has four side faces and a square cross-section and is shaped and sized to fit within each of the plurality of retention cells, wherein each of the four side faces of the peg of the first wheel assembly frictionally holds the peg within a first of the retention cells;
a blade assembly comprising a first post and a glass scoring blade attached to the first post, wherein the first post of the blade assembly comprises a peg on an end of the first post of the blade assembly, wherein the peg of the blade assembly is unitary with the first post of the blade assembly, wherein the peg of the blade assembly has four side faces and a square cross-section and is shaped and sized to fit within each of the plurality of retention cells, wherein each of the four side faces of the peg of the blade assembly frictionally holds the peg of the blade assembly within a second of the retention cells.

2: The bottle scoring apparatus of claim 1 wherein the peg on the post of the first wheel assembly is configured to be removed from the first cell of the plurality of retention cells.

3: The bottle scoring apparatus of claim 2 wherein the peg on the post of the first wheel assembly is configured to be frictionally held within a third cell of the plurality of retention cells.

4: The bottle scoring apparatus of claim 1 wherein the peg on the first post of the blade assembly is configured to be removed from the second cell of the plurality of retention cells.

5: The bottle scoring apparatus of claim 4 wherein the peg on the first post of the blade assembly is configured to be frictionally held within a fourth cell of the plurality of retention cells.

6: The bottle scoring apparatus of claim 1 wherein the blade assembly comprises a second post, wherein the second post comprises a peg on an end thereof, wherein the glass scoring blade is held between the first post and the second post, wherein the peg on the second post of the blade assembly is frictionally held within a third cell of the plurality of retention cells.

7: The bottle scoring apparatus of claim 6 wherein both the peg on the first post of the blade assembly and the peg on the second post of the blade assembly are configured to be removed from the first cell and the third cell of the plurality of retention cells, respectively.

8: The bottle scoring apparatus of claim 7 wherein the peg on the first post of the blade assembly and the peg on the second post of the blade assembly are configured to be frictionally held within a fourth cell and a fifth cell of the plurality of cells, respectively.

9: The bottle scoring apparatus of claim 1 further comprising:
a second wheel assembly comprising a post, a rotating wheel attached to the post, and a peg on an end of the post, wherein the peg on the post of the second wheel assembly is shaped and sized to fit within the plurality of retention cells, wherein the peg on the post of the second wheel assembly is frictionally held within a third cell of the plurality of retention cells.

10: The bottle scoring apparatus of claim 9 wherein the first wheel assembly and the second wheel assembly are positioned on the base to hold a bottle therebetween, wherein the rotating wheels of the first and second wheel assemblies, respectively, rotate the bottle held thereon.

11: The bottle scoring apparatus of claim 9 further comprising:
a third wheel assembly comprising a post, a rotating wheel attached to the post, and a peg on an end of the post, wherein the peg is shaped and sized to fit within the plurality of retention cells, wherein the peg on the post of the third assembly is frictionally held within a fourth cell of the plurality of retention cells.

12: The bottle scoring apparatus of claim 11 wherein the first wheel assembly, the second wheel assembly, and the third wheel assembly are positioned on the base to hold a bottle thereon, wherein the rotating wheels of the first, second and third wheel assemblies, respectively, allow the bottle to be rotated thereon.

13: The bottle scoring apparatus of claim 1 further comprising:
a stopper assembly comprising a post, a stopper attached to the post, and a peg on an end of the post, wherein the peg on the post of the stopper assembly is sized and shaped to fit within the plurality of retention cells, wherein the peg on the post of the stopper assembly is frictionally held within a third cell of the plurality of retention cells.

14: The bottle scoring apparatus of claim 1 wherein the peg on the post of the stopper assembly is configured to be removed from the third cell of the plurality of cells.

15: The bottle scoring apparatus of claim 1 wherein the peg on the post of the stopper assembly is configured to be frictionally held to a fourth cell of the plurality of retention cells.

16: The bottle scoring apparatus of claim 13 wherein the stopper is adjustable towards and away from the post of the stopper assembly.

17: The bottle scoring apparatus of claim 16 wherein the stopper comprises a stopper element, a threaded shaft extending from the stopper element through the post of the stopper assembly, and a dial attached on an end of the threaded shaft, wherein the stopper is adjustable towards and away from the post of the stopper assembly via turning the dial and the threaded shaft.

18: The bottle scoring apparatus of claim 1 wherein the first wheel assembly and the blade assembly are configured to move to different locations on the base to accommodate different sized bottles thereon.

19: A method of using the bottle scoring apparatus of claim 1 comprising the steps of:
removing the first wheel assembly from the first cell of the plurality of retention cells; and
placing the peg of the post of the first wheel assembly in a third cell of the plurality of cells, wherein the peg of the post of the first wheel assembly is frictionally held within the third cell of the plurality of cells.

20: The method of using the bottle scoring apparatus of claim 19 further comprising the steps of:
removing the blade assembly from the second cell of the plurality of retention cells; and
placing the peg on the first post of the blade assembly in a fourth cell of the plurality of retention cells.
